(19) United States
(12) Patent Application Publication
(10) Pub. No.: US 2012/0255214 A1
(43) Pub. Date: Oct. 11, 2012

(54) REMOTELY CONTROLLED ANIMAL MOTION DECOY SYSTEM

(76) Inventors: Thomas B. Krocheski, Cambridge, MD (US); James S. Taylor, Glen Arm, MD (US); James W. Senior, East New Market, MD (US)

(21) Appl. No.: 13/082,719

(22) Filed: Apr. 8, 2011

(51) Int. Cl. A01M 31/06

(52) U.S. Cl. 43/3

(57) ABSTRACT

A system configured to imitate actions of a group of animals includes a plurality of decoys. Each of the decoys includes anatomical body parts that are representative of an animal being imitated. Each decoy is capable of making a plurality of body motions in a predefined sequence. The system also includes a motion mechanism located inside the body of each decoy, wherein the motion mechanism is configured to control the plurality of body motions. The system further includes a control terminal including a plurality of button sets, with each set being associated with a switch group and each switch group being used to send a control message to a receiver of the motion mechanism of a particular decoy. Operation of the switch groups causes animation of groups of the plurality of decoys in a programmable or random manner.

### BACKGROUND OF THE INVENTION

1. Field of the invention

The present invention is directed to an automated electromechanical system for imitating actions of at least one animal decoy.

2. Description of the Related Art

Animal decoys are typically used to attract other animals of interest. For example, fowl decoys in the form of geese, ducks or other game birds are used to attract fowl for hunting. There are various types of fowl decoys of varying sizes. Some of these decoys float, while others are hollow with feet and are placed in low brush or other terrain to give the appearance of the decoy standing in the terrain.

So as to impart a more life-like appearance to a decoy and enhance the effect of the decoy to attract animals of interest, there have been various attempts to enhance the functions of a single decoy by moving one or more parts of the decoy. Although movable decoys are more effective than their stationary predecessors, considering that some animals, for example fowl, typically move in groups, one of the disadvantages of current decoys is the inability to mimic actual group movements of multiple animals of interest.

### SUMMARY OF THE INVENTION

Embodiments of the present invention may be directed to a system configured to imitate actions of a group of animals. The system includes a plurality of decoys. Each of the decoys includes anatomical body parts that are representative of an animal being imitated. Each decoy is capable of making a plurality of body motions in a predefined sequence. The system also includes a motion mechanism located inside the body of each decoy, wherein the motion mechanism is configured to control the plurality of body motions. The system further includes a control terminal including a plurality of button sets, with each set being associated with a switch group and each switch group being used to send a control message to a receiver of the motion mechanism of a particular decoy. Operation of the switch groups causes animation of groups of the plurality of decoys in a programmable or random manner. Further, these embodiments can be used in conjunction with other passive decoys to present a larger flock simulation.

Another embodiment of the present invention may be directed to a method for imitating actions of a group of animals. The method includes sending a control message from a switch group of a control terminal comprising a plurality of button sets; receiving the control message by a motion mechanism located inside the body of each decoy of a plurality of decoys, wherein the motion mechanism is configured to control a plurality of motions of the decoy; and using the control message to animate in groups of the plurality of decoys, in a programmable or random manner, anatomical body parts that are representative of an animal being imitated, wherein each decoy is capable of making a plurality of body motions in a predefined sequence.

Another embodiment of the present invention may be directed to an apparatus for imitating actions of a group of animals. The apparatus includes sending means for sending a control message from a switch group of a control terminal comprising a plurality of button sets. The apparatus also includes receiving means for receiving the control message by a motion mechanism located inside the body of each decoy of a plurality of decoys, wherein the motion mechanism is configured to control a plurality of motions of the decoy. The apparatus further includes means for using the control message to animate in groups of the plurality of decoys, in a programmable or random manner, anatomical body parts that are representative of an animal being imitated, wherein each decoy is capable of making a plurality of body motions in a predefined sequence.

### BRIEF DESCRIPTION OF THE DRAWINGS

FIG. 1 illustrates an example of a waterfowl decoy that may be used in embodiments of the present invention;

FIG. 2 illustrates an embodiment of a motion mechanism that may be used in embodiments of the present invention;

FIG. 3 illustrates an embodiment of a remote control that may be used in embodiments of the present invention;

FIG. 4 illustrates an embodiment of a side view of the waterfowl decoy;

FIG. 5 illustrates an embodiment of the waterfowl decoy with an elevated body;

FIG. 6 illustrates an embodiment of a rear view of the waterfowl decoy;

FIG. 7 illustrates an embodiment of a front view of the waterfowl decoy; and

FIG. 8 illustrates another embodiment of the front view of the waterfowl decoy.

### DETAILED DESCRIPTION OF EMBODIMENTS

Embodiments of the present invention may incorporate unique devices and configurations along with conventional components to accomplish a more complete simulation of animal movements in a wide range of environments. Embodiments of the present invention also may enable substantially greater flexibility in changing movement characteristics and sequences during field operations. For example, different movements can be made separately or activated at the same time to simulate the way an animal motion occurs when that motion is made in a particular environment or under a particular condition. Embodiments of the present invention may also permit control of multiple decoys via various means for communications, for example, wired links, radio control links, or blue tooth links. Embodiments of the present invention may further incorporate means for calibrating and revising decoys motions in the field.

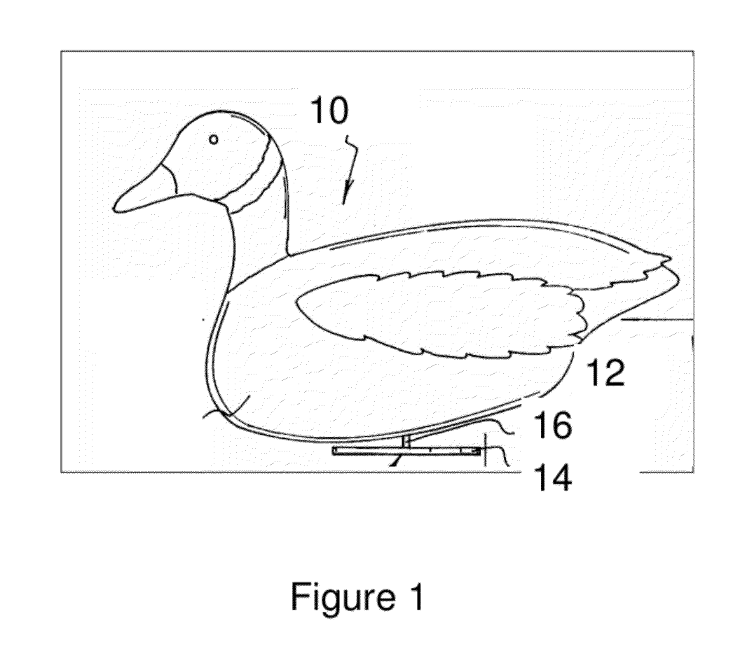

To illustrate representative capabilities of embodiments of the present invention, the actions of a feeding waterfowl, illustrated in FIG. 1, is discussed below. It should be noted, however, that embodiments of the invention are not limited to waterfowl and the discussion of waterfowl is only provided as an illustration of some of the capabilities of the invention. Canada geese and cormorants often rise from a resting or feeding position to exercise their wings. In a group, different birds do this at different times, creating a random appearance across the group to persons or other animals observing the flock. Therefore, embodiments of the present invention may be directed to controlling animation of multiple decoys from a single remote location to achieve an accurate group appearance.

In particular, decoy 10 may be set up so that individual body motions operate independently or concurrently for desired effects according to programmable settings. Each decoy and its motions can be controlled and modified in the field to, for example, revise start times, durations, rates, or ranges of each motion. This provides the flexibility to make more effective, active simulations of an animal's activities.

An embodiment of the present invention may be directed to an automated electromechanical system that imitates the actions of an animal, for example, a goose feeding in the field. The system may be operated from a remote location by using, for example, either a cable connection or an electro-magnetically connected remote control. Because a decoy in the system can imitate the motions of a goose in the field, it is suitable for use in applications where animal movements are needed. The system may be operated indoors or outdoors over a wide range of temperatures and weather for long periods of time.

The operations of the inventive system can be automated or controlled by an operator. The automated operation is discussed below, although it is not the only means of operating the inventive system. In an embodiment of the invention, decoy 10 of the system may be capable of making several body motions. The motions may include movement of the body from a horizontal position to a nominal elevation angle of, for example, 45° to 60°. The motions may also include movement of the decoy's wings 12 from a folded position along the back of the decoy out to an extended position at approximately 90° to the body axis, flapping of the wings over a typical total angle of approximately 90°, and movement of the decoy from an eating position to that of the flapping position.

In the automatic mode, these motions may be made sequentially, for example, with the body lifting up, the wings opening, and wings flapping. The number of times each motion is made can be set to different values that are selectable or programmable by the operator. For example, one setting of the number of times the wings flap may provide for six flaps of the wings and another setting may provide for ten flaps of the wings. After the programmable motion sequences are completed, decoy 10 may move to another position. For example, after the wings 12 have completed the selected number of flaps, the wings 12 may fold back and return to the stowed position and the body may move down in angle to the horizontal again.

Decoy 10 may stand on metal legs 14 that extend into holes in the ground, for example during outdoor use. The holes in the ground can be placed at an angle to hold the decoy's body, for example, at approximately a horizontal position or a slight elevation of 10 to 20°. Slots 16 in the lower belly of the decoy may allow legs 14 to stick out and allow the body to move with respect to the legs as it elevates.

The exterior body of the decoy may be constructed from a commercial decoy body or made from raw materials, as a custom-made body. The body may be a basic thin shell of plastic. It should be apparent to one of ordinary skill in the art that rubber or other materials may also be used for the decoy body construction.

The wing may be constructed of a long rod or tube, at the leading edge, that carries flexible cloth, plastic, or other material to simulate the feathers of the wing. A thin cloth or other material may be used in a triangular shape with one side attached to the rod that forms the leading edge of the wing. The other side may be attached to the exterior of the body shell of the decoy. When assembled, the thin material may be held taut while the wing is extended and folded down when the wing is in the stowed position along the body. The shape of the wing rod may be formed to provide a bend in the leading edge of the wing as one sees in a real bird. This also makes the ends of the wings fold close to the tail of the body, as they are with a real bird.

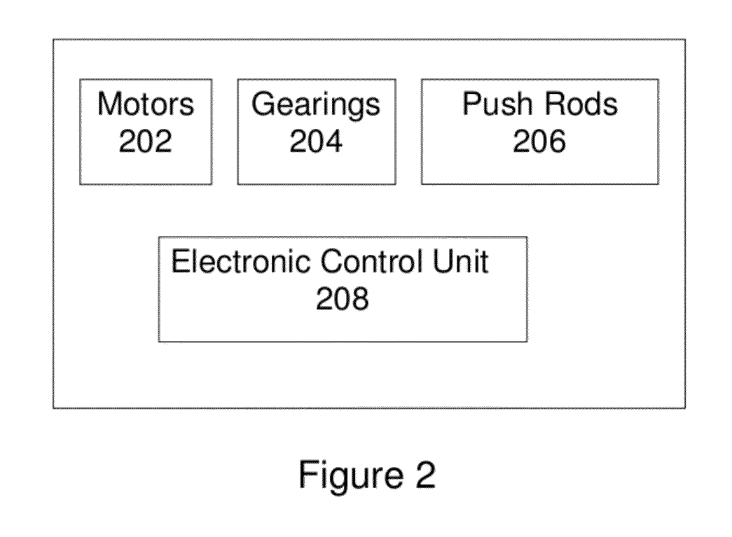

FIG. 2 illustrates an embodiment of a motion mechanism that may be used in embodiments of the present invention. The motion mechanism 200 may include motors 202, gearing 204, push rods 206, and an electronic control unit 208. Power for the decoy may be provided by an external source. The external power source, for example a battery, may be located between the decoy's legs 14, just behind the decoy on the ground, or on a short board if the unit is being operated indoors. The motors 202 that run the decoy and the gear ratios employed may be selected/programmed to make various motions occur at rates comparable to those of a live goose. By controlling the voltages and pulse widths of the power supplied, motor speeds can be varied for each motor individually. If a motor 202 is used for more than one function, then the gearing can be adjusted to give the appropriate motion rate for each function as it occurs.

The decoy body can be constructed with an opening for placing the motion mechanism inside the body. Small apertures on each side of the body shell may be used to connect wings 12. The body may be attached to the motion mechanism with screws or studs that extend through small holes in the back of the decoy into receptacles on the top of the motion mechanism. It should be noted that other attachment means for attaching the body to the motion mechanism are within the scope of the invention.

As noted above, three basic motions may be performed in sequence—the body rising, the wings folding out, and then the wings flapping. However, is should be noted that the sequence of the body motions may vary. For example, the sequence of the body motions may include the raising of the body and the unfolding of the wings occurring simultaneously or in an overlapping of the durations of these motions.

A body elevation motor can have a direct gear to drive the leg support of the decoy to raise the body to a pre-selected angle. The pre-selected angle may be controlled by software in the electronic control unit and the duration of the power pulse train it supplies to the elevation motor. Limit switches at each end of the travel may prevent over travel by the elevation drive.

The rotation and flapping of the wings may be controlled from their respective motors through gear trains that drive wheels connected to a dual axis joint for each wing. A mechanical rod extending from a rotating wheel to a pin on the dual action joint may provide the connection between the drive wheel and the joint. In an embodiment of the invention, there may be four rods, two connected to each rotation wheel. The dual axis joint may allow the root of the wing to rotate from the stowed position on the back of the decoy to the extended position at approximately 90° and also may allow for the extended wing to be moved up and down with a flapping motion powered by the flapping motor. The duration of the wing extension and the flapping time may be controlled thorough the motors by the electronic control unit.

The electronic control unit may include a microprocessor to receive operator control signals from a remote control terminal and software to control the activation of the different motors and thereby define the actions of the decoy. The remote control permits the operator to select different automatic modes of operation. There may also be a number of switches and timers under the control of the microprocessor in the decoy that control drive motors and thus the angular motions of the body and the wings over a complete motion sequence.

In an embodiment, the decoy may be relatively lightweight, approx. 10 lbs. with removable legs so that it can be stored in a small volume. The battery pack may be a separate small box whose weight depends on the type of battery and the energy storage capacity consistent with the operating time expected for the decoy. The overall size of the decoy will generally be determined by the size of the body shell used. Similarly, the wingspan may be chosen to match the selected body shell size. The automatic wing folding and folding/removable legs make for compactness in storage and travel.

Embodiments of the present invention also may include provisions for recalibration and recovery from malfunctions in the field. Embodiments of the invention also include a unique joint that permits three degrees of wing rotational motion (yaw, pitch, and roll) in a compact package consistent with waterfowl body sizes.

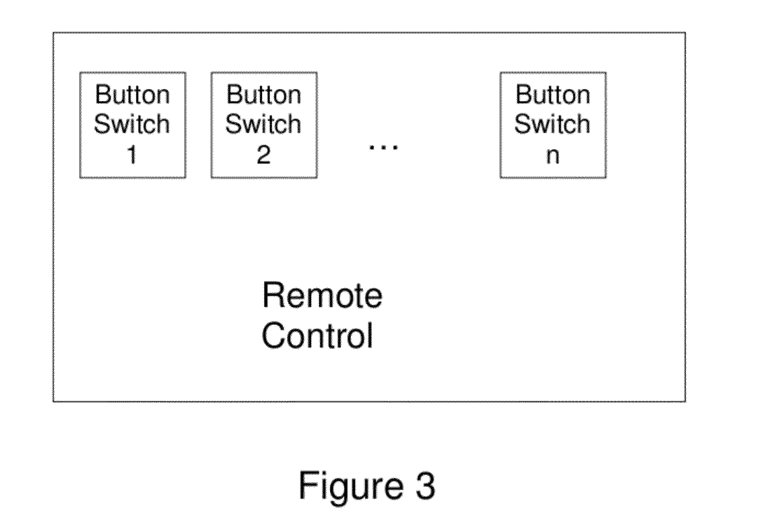

Embodiments of the present invention may be directed to operation of multiple decoys from a single remote control. One embodiment may use a remote control that has multiple buttons, with a set of buttons associated with a switch group, as illustrated in FIG. 3. Each button in the switch group may therefore be used to send a message from that switch group to a particular decoy. The signals generated by each particular switch/button may be sent to a specific decoy by wiring, electro-magnetically or acoustic means. Despite the method of signal transmission, in an embodiment of the invention, a receiver associated with an individual decoy may be set to respond to the code of only one switch group.

In an alternate embodiment, the receiver may be set to respond to codes associated with multiple switch groups. For example, each switch group on the remote control might transmit information on a unique frequency. In another example, each switch group on the remote control might have different time spacing between the first and second pulses or might have a unique sequence of pulses. In any case, operating the switch groups at random times can cause the associated decoys to operate at random times.

Alternatively, the random times for individual decoys to operate can be programmed into the decoy's processor and the remote buttons may be used to start each decoy's random sequence. The encoding can keep decoys from receiving false signals or signals from another owner of decoys. Embodiments of the present invention also enable an individual to have as many decoys in the field as desired, wherein multiple remote controls can be used to animate different groups of decoys.

The flexibility provided by button selection and simple coding in a remote control and related decoy's internal processors enables a number of other capabilities for these decoys. For example, coded messages transmitted from the remote control to a decoy's processor may initiate calibration, tests, status reporting, and changes in operating modes, through the processor in each decoy. Each decoy may also include a transmitter to transmit information, such as, the decoy's status to the remote control.

Embodiments of the integrated system of the present invention can be configured to animate decoys associated with different animals and simulation techniques to provide a variety of motions and activity sequences. Therefore, embodiments of the present invention have many more capabilities for operation, testing and mode changes than existing systems.

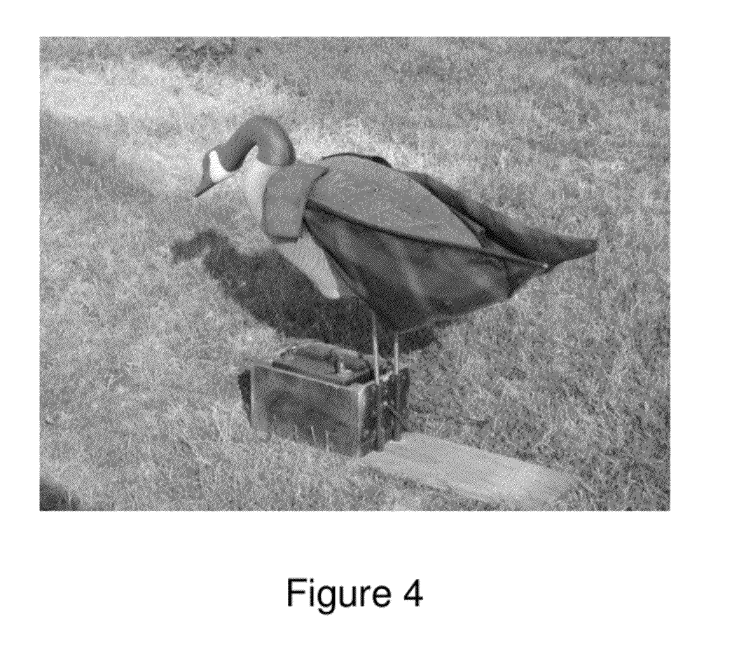

FIG. 4 illustrates an embodiment of a side view of the waterfowl decoy. In this embodiment, the wings of the waterfowl are folded. The waterfowl decoy is mounted on a board (for indoor demonstrations). This embodiment of the waterfowl decoy includes temporary flaps as one way to conceal the wing joints.

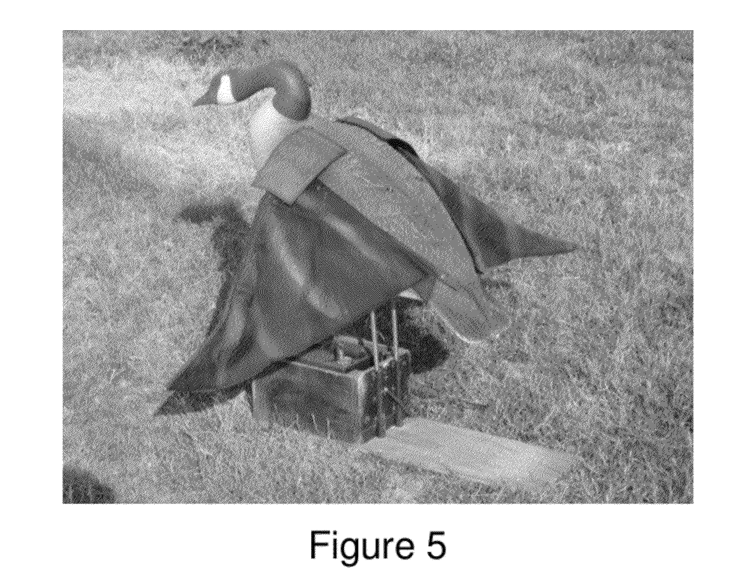

FIG. 5 illustrates an embodiment of the waterfowl decoy with an elevated body. In this embodiment the body of the waterfowl decoy is elevated about 40 degrees with wings extended near the lowest point in the flapping cycle. In this embodiment, the battery will normally be located away from the waterfowl decoy

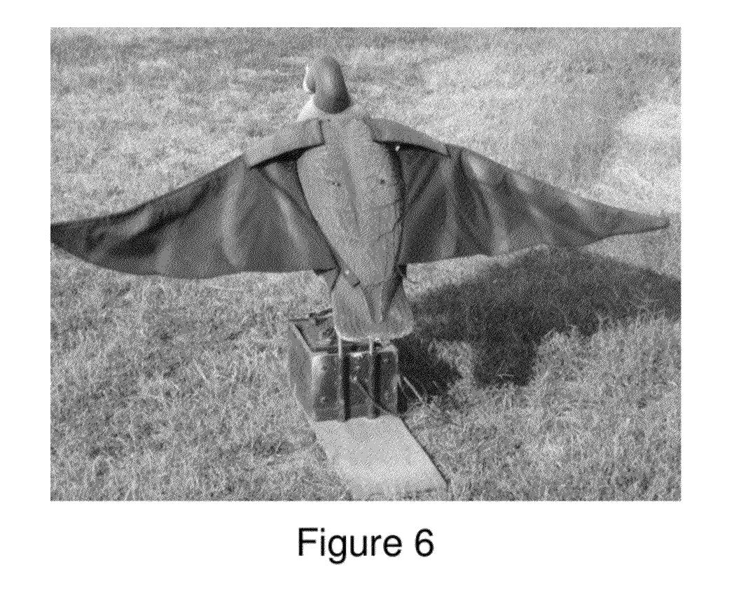

FIG. 6 illustrates an embodiment of a rear view of the waterfowl decoy. In this embodiment, the body of the waterfowl decoy is elevated about 40 degrees and the wings are near the top of the flapping cycle movement.

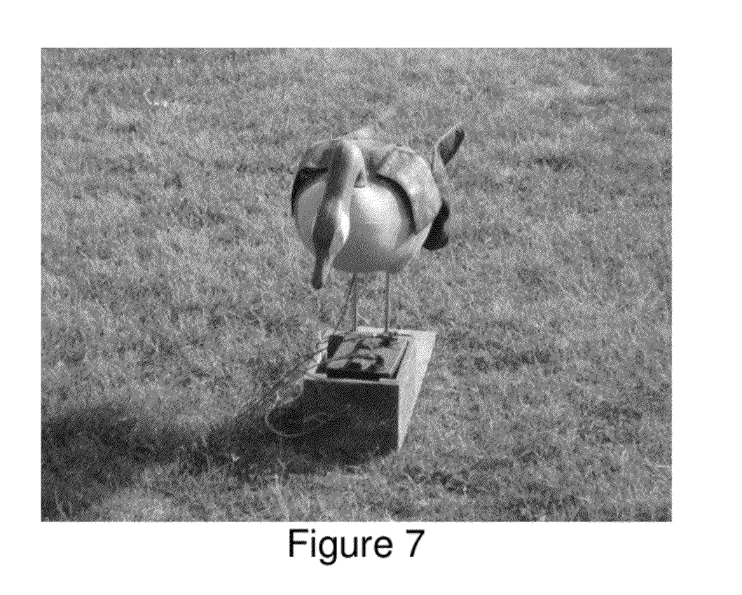

FIG. 7 illustrates an embodiment of a front view of the waterfowl decoy. In this embodiment, the body of the waterfowl decoy is near a horizontal position and the wings are folded.

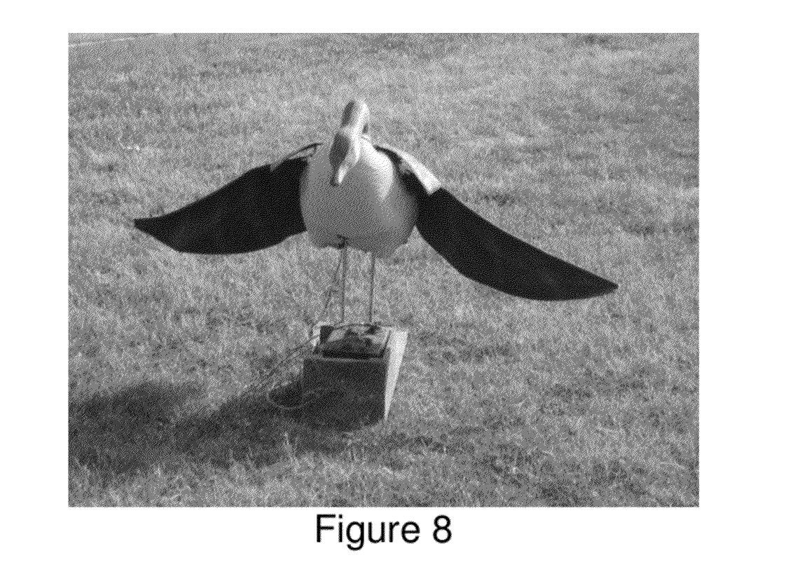

FIG. 8 illustrates another embodiment of the front view of the waterfowl decoy. In this embodiment, the wings are near the midpoint of the flapping cycle.

Although the present invention has been shown and described with respect to certain embodiments, it should be understood by those skilled in the art that various modifications can be made to the inventive testing device and the method of the instant invention without departing from the scope and spirit of the invention. It is intended that the present invention cover modifications and variations of the inventive testing device and method provided they come within the scope of the appended claims and their equivalents

What is claimed:

1. A system configured to imitate actions of an animal or a group of animals, comprising:
a plurality of decoys, each of the decoys including anatomical body parts that are representative of an animal being imitated, wherein each decoy is capable of making a plurality of body motions in a predefined sequence;
a motion mechanism located inside the body of each decoy, wherein the motion mechanism is configured to control the plurality of body motions;
a control terminal comprising a plurality of button sets, with each set being associated with a switch group and each switch group being used to send a control message to a receiver of the motion mechanism of a particular decoy such that operation of the switch groups causes animation of groups of the plurality of decoys in a programmable or random manner.

2. The system of claim 1, wherein the control terminal is remote from the plurality of decoys and signals generated by each switch group is sent to a specific decoy or groups of decoys.

3. The system of claim 1, wherein signals generated from the control terminal may initiate at least one of calibration, test, status reporting, or changes in operating modes of a specific decoy or groups of decoys.

4. The system of claim 1, wherein the predefined sequence of body motions include a plurality of body motions occurring in at least one of a sequential order or simultaneously.

5. The system of claim 1, wherein the receiver of each decoy is set to correspond to a predefined number of switch groups.

6. The system of claim 1, wherein the motion mechanism comprises at least one of motors and gearing for animating one or more anatomical body parts, push rods, or an electronic control unit configured to control the motors and gearings.

7. The system of claim 6, wherein the electronic control unit comprises a microprocessor to receive control signals from the control terminal and to control activation of various motors.

8. The system of claim 6, wherein motor and gear ratios may be selected or programmed to make various motions occur at rates comparable to those of the animal being imitated.

9. The system of claim 6, wherein the motor speed for each motor can be varied by controlling voltages and pulse widths of supplied power to the motion mechanism.

10. The system of claim 6, wherein the motion mechanism comprises an elevation motor configured to raise the body of the decoy to a pre-selected angle.

11. The system of claim 1, wherein each decoy is powered by an external source.

12. The system of claim 1, wherein the body of each decoy is attached to the motion mechanism with screws that extend through holes in the back of the decoy into receptacles on the top of the motion mechanism.

13. The system of claim 1, wherein the plurality of body motions include movements to a plurality of positions of various components of the decoy that corresponds to anatomical body parts, thereby imitating movement of the animal.

14. The system of claim 1, wherein the number of times each body motion is made is programmable or selectable by an operator.

15. A method for imitating actions of an animal or a group of animals, comprising:
sending a control message from a switch group of a control terminal comprising a plurality of button sets;
receiving the control message by a motion mechanism located inside the body of each decoy of a plurality of decoys, wherein the motion mechanism is configured to control a plurality of motions of the decoy; and
using the control message to animate in groups of the plurality of decoys, in a programmable or random manner, anatomical body parts that are representative of an animal being imitated, wherein each decoy is capable of making a plurality of body motions in a predefined sequence.

16. The method of claim 15, further comprising sending signals generated by each switch group to a specific decoy or groups of decoys that are remote from the control terminal.

17. The method of claim 15, further comprising initiating at least one of calibration, test, status reporting, or changes in operating modes of a specific decoy or groups of decoys with signals generated from the control terminal.

18. The method of claim 15, further comprising setting the receiver of each decoy to correspond to a predefined number of switch groups.

19. The method of claim 15, further comprising receiving control signals from the control terminal by an electronic control unit of the motion mechanism, wherein the electronic control unit comprises a microprocessor to receive and to control activation of various motors and gears associated with the motion mechanism.

20. The method of claim 15, further comprising selecting or programming motor and gear ratios associated with motors and gearing of the motion mechanism, wherein the motors and gears are for animating one or more anatomical body parts to make various motions occur at rates comparable to those of the animal being imitated.

21. The method of claim 20, further comprising varying the motor speed for each motor by controlling voltages and pulse widths of supplied power to the motion mechanism.

22. The method of claim 15, further comprising including a transmitter along with a receiver in the body of a first decoy so control messages can be forwarded from the first decoy to at least one other decoy that is a distance away from the first decoy.

23. An apparatus for imitating actions of a group of animals, comprising:
sending means for sending a control message from a switch group of a control terminal comprising a plurality of button sets;
receiving means for receiving the control message by a motion mechanism located inside the body of each decoy of a plurality of decoys, wherein the motion mechanism is configured to control a plurality of motions of the decoy; and
means for using the control message to animate in groups of the plurality of decoys, in a programmable or random manner, anatomical body parts that are representative of an animal being imitated, wherein each decoy is capable of making a plurality of body motions in a predefined sequence.
